(19) United States
(12) Patent Application Publication
(10) Pub. No.: US 2011/0223913 A1
(43) Pub. Date: Sep. 15, 2011

(54) APPARATUS AND METHOD FOR CONTROLLING STATUS OF FEMTOCELL IN BROADBAND WIRELESS COMMUNICATION SYSTEM

(75) Inventors: Young-Sung KHO, Seongnam-si (KR); Dong-Min KIM, Seoul (KR); Tae-Hyoun KIM, Suwon-si (KR)

(73) Assignee: SAMSUNG ELECTRONICS CO. LTD., Suwon-si (KR)

(21) Appl. No.: 13/028,430

(22) Filed: Feb. 16, 2011

(30) Foreign Application Priority Data
Mar. 10, 2010 (KR) 10-2010-0021082

(51) Int. Cl. H04W 60/00; H04W 52/00; H04W 88/02

(52) U.S. Cl. 455/435.1; 455/422.1; 455/550.1

(57) ABSTRACT

An apparatus and a method for operating a terminal in a broadband wireless communication system including a macrocell and a femtocell are provided. The method includes receiving femtocell information relating to a femtocell to which the terminal is registered, determining whether the terminal enters a region where the femtocell belongs, using the femtocell information, when entering the region where the femtocell belongs, transmitting a message to wake up the femtocell, and searching for the femtocell.

### PRIORITY

This application claims the benefit under 35 U.S.C. §119(a) of a Korean patent application filed in the Korean Intellectual Property Office on Mar. 10, 2010 and assigned Serial No. 10-2010-0021082, the entire disclosure of which is hereby incorporated by reference.

### BACKGROUND OF THE INVENTION

1. Field of the Invention

The present invention relates to a broadband wireless communication system. More particularly, the present invention relates to an apparatus and a method for controlling status of a femtocell in a broadband wireless communication system.

2. Description of the Related Art

A femtocell addresses a service shadow area in a wireless communication system. The femtocell is a cell formed by an indoor micro base station. According to the femtocell technology, a user can inexpensively install a mobile communication base station indoors. Even when the user travels from the coverage area of a macrocell to the coverage area of the femtocell, high-speed data service can be sustained without replacement of a communication device or a separate manipulation. More particularly, the femtocell technology can provide the user in the service shadow area with the same service quality as the indoor base station nearby.

The femtocell and the macrocell can use the same frequency band or different frequency bands. When the femtocell and the macrocell utilize the same frequency band, a terminal can search for the femtocell in the same manner as a general macrocell search. In this case, the search for the femtocell is easy, but a signal of the femtocell can interfere with a signal of the macrocell, which can adversely affect the performance of the macrocell. When the femtocell and the macrocell utilize different frequency bands, the terminal needs to measure the signal in the frequency band allocated to the femtocell, not in the current frequency band, so as to search for the femtocell. In so doing, power consumption of the terminal increases and the service is disrupted during the time taken to measure the signal.

In addition, the femtocell needs to continuously transmit signals even when there is no user currently accessing the femtocell so that the terminal registered to the femtocell can search for the femtocell. As a result, power of the femtocell is unnecessarily wasted and the macrocell experiences continuous signal interruption. In addition, the terminal needs to keep searching for the registered femtocell despite its registered femtocell not being in its vicinity.

Therefore, a need exists for an apparatus and a method for preventing unnecessary signal transmission of a femtocell in a broadband wireless communication system.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for preventing unnecessary signal transmission of a femtocell in a broadband wireless communication system.

Another aspect of the present invention is to provide an apparatus and a method for preventing performance degradation of a macrocell caused by a signal of a femtocell in a broadband wireless communication system.

Yet another aspect of the present invention is to provide an apparatus and a method for reducing power consumption of a terminal in femtocell search in a broadband wireless communication system.

Still another aspect of the present invention is to provide an apparatus and a method for preventing communication performance degradation of a terminal in femtocell search in a broadband wireless communication system.

In accordance with an aspect of the present invention, a method for operating a terminal in a broadband wireless communication system including a macrocell and a femtocell is provided. The method includes receiving femtocell information relating to a femtocell to which the terminal is registered, determining whether the terminal enters a region where the femtocell belongs, using the femtocell information, when entering the region where the femtocell belongs, transmitting a message to wake up the femtocell, and searching for the femtocell.

In accordance with another aspect of the present invention, a method for operating a femto base station in a broadband wireless communication system including a macrocell and a femtocell is provided. The method includes collecting information of at least one neighboring macrocell, transmitting femtocell information comprising the information of the neighboring macrocell, to a femtocell manager and a terminal registered to the femto base station, and when receiving a wakeup command, transitioning to a wakeup status.

In accordance with another aspect of the present invention, an apparatus of a terminal in a broadband wireless communication system including a macrocell and a femtocell is provided. The apparatus includes a modem for receiving femtocell information relating to a femtocell to which the terminal is registered, and a controller for determining whether the terminal enters a region where the femtocell belongs, using the femtocell information, for controlling to transmit a message to wake up the femtocell when entering the region where the femtocell belongs, and for searching for the femtocell.

In accordance with another aspect of the present invention, an apparatus of a femto base station in a broadband wireless communication system including a macrocell and a femtocell is provided. The apparatus includes a transmitter for transmitting femtocell information comprising information of at least one neighboring macrocell, to a femtocell manager and a terminal registered to the femto base station, and a controller for collecting the information of the at least one neighboring macrocell, and for transitioning to a wakeup status when receiving a wakeup command.

Other aspects, advantages, and salient features of the invention will become apparent to those skilled in the art from the following description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a simplified construction of a wireless communication system according to an exemplary embodiment of the present invention;

FIG. 2 illustrates signal exchange for initial registration of a femtocell in a broadband wireless communication system according to an exemplary embodiment of the present invention;

FIGS. 3A and 3B illustrate signal exchanges for a wakeup status transition of a femtocell in a broadband wireless communication system according to an exemplary embodiment of the present invention;

FIG. 4 illustrates a method for changing the status of a femto base station in a broadband wireless communication system according to an exemplary embodiment of the present invention;

FIG. 5 illustrates a method for searching for a femtocell at a terminal in a broadband wireless communication system according to an exemplary embodiment of the present invention;

FIG. 6 is a block diagram of a femto base station in a broadband wireless communication system according to an exemplary embodiment of the present invention; and

FIG. 7 is a block diagram of a terminal in a broadband wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for, when a femtocell and a macrocell are used together, minimizing influence on a neighboring macrocell and unnecessary power consumption of the femtocell by controlling status of the femtocell in a wakeup/sleep mode, and searching for the femtocell only when a terminal approaches a particular region.

Hereinafter, an Orthogonal Frequency Division Multiplexing (OFDM)/Orthogonal Frequency Division Multiple Access (OFDMA) wireless communication system is exemplified. Exemplary embodiments of the present invention are equally applicable to other wireless communication systems.

While terms defined in 3rd Generation Partnership Project (3GPP) Long Term Evolution (LTE) standard are used to ease the understanding, the present invention is equally applicable to other communication systems as well as 3GPP LTE systems.

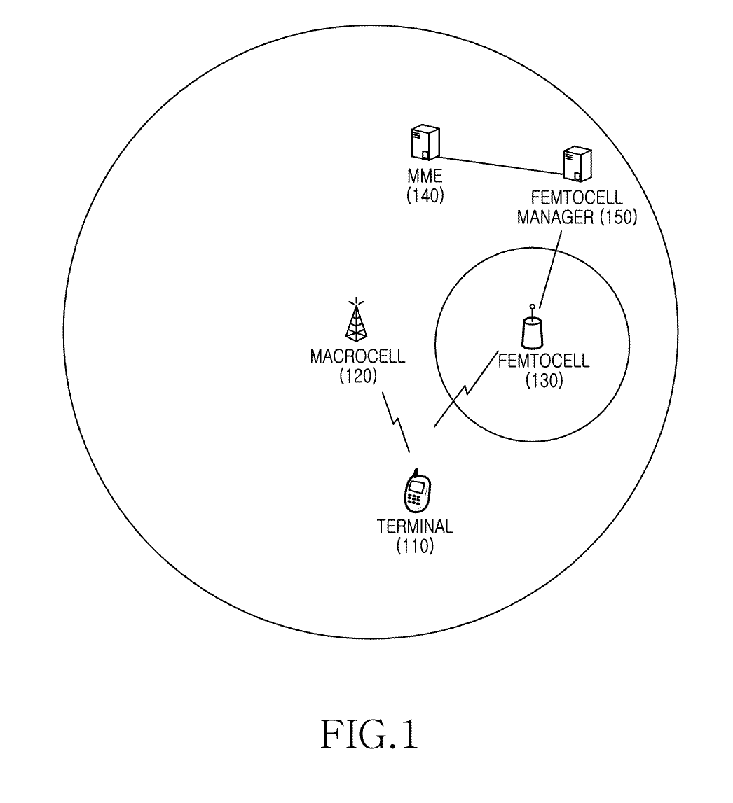

FIGS. 1 through 7, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 illustrates a simplified construction of a wireless communication system according to an exemplary embodiment of the present invention.

Referring to FIG. 1, a wireless communication system includes a terminal 110, a macrocell 120, a femtocell 130, a Mobile Management Entity (MME) 140, and a femtocell manager 150.

The terminal 110, which is a user equipment, communicates with the macrocell 120 and the femtocell 130 over radio channels. The macrocell 120 is a coverage area of a macro base station installed by a provider. In exemplary embodiments of the present invention, the macrocell 120 indicates the coverage area of the macro base station and the macro base station at the same time. The femtocell 130 is a coverage area of a femto base station installed by a user. Herein, the femtocell 130 indicates the coverage area of the femto base station and the femto base station as well. The MME 140 is a core equipment for managing location of the terminal and a travel path of the terminal The MME 140 is connected to the macrocell 120 and the femtocell manager 150 over a backhaul network. The femtocell manager 150 manages femtocells installed in the network. The femtocell manager 150 obtains distribution of the femtocells and terminals registered to the femtocells, and controls an operation mode of the femtocells. The femtocell manager 150 is connected to the femtocell 130 and the MME 140 over the backhaul network.

Characteristics of the system according to an exemplary embodiment of the present invention are explained in brief by referring to FIG. 1. In a case where the terminal 110 is registered as a user accessible to the femtocell 130, the femtocell 130 operates in a wakeup mode when the terminal 110 enters a particular region and operates in a sleep mode when the terminal 110 gets out of the particular region. Herein, the particular region includes at least one Tracking Area (TA). Since the MME 140 is tracking the current TA of the terminal 110, the MME 140 can know which particular region the terminal 110 enters. However, the MME 140 does not know whether the femtocell 130 is present in the current TA of the terminal 110. Accordingly, upon entering a particular TA, the terminal 110 informs the MME 140 of the existence of the femtocell 130 in the TA. The MME 140 notifies the femtocell manager 150 that the terminal 110 enters the TA. Thus, the femtocell manager 150 commands the registered femtocell 130 of the terminal 110 to wake up.

The macrocell 120 is paired with some of the femtocell 130 and other femtocells, and the femtocell 130 is paired with some of the macrocell 120 and other macrocells. Thus, the terminal 110 searches for the femtocell 130 only when it enters the macrocell paired with its registered femtocell 130, and stops searching when it leaves the paired macrocell.

Detailed operations for searching for the femtocell and controlling the operation mode of the femtocell are described below.

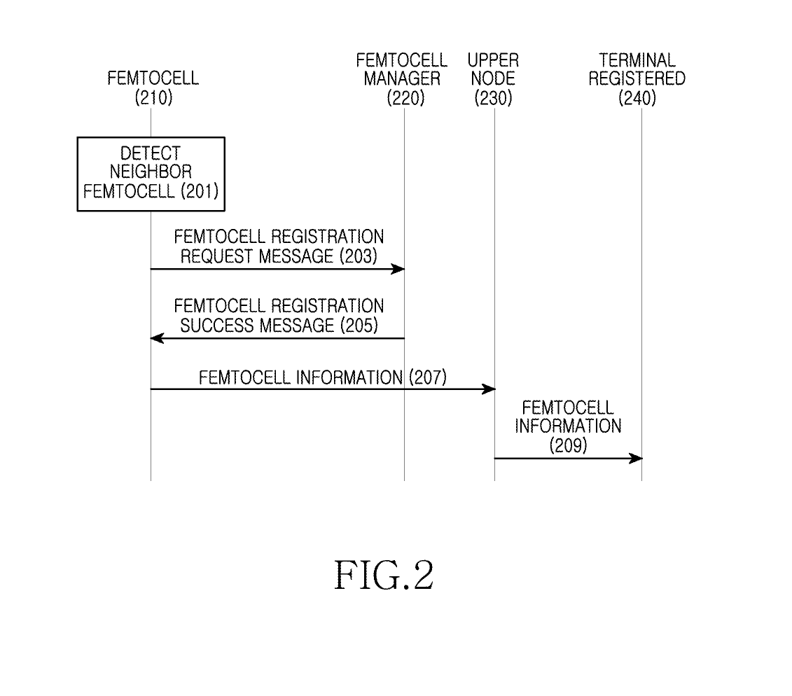

FIG. 2 illustrates signal exchange for initial registration of a femtocell in a broadband wireless communication system according to an exemplary embodiment of the present invention.

Referring to FIG. 2, a femtocell 210 applies the initial power and then searches for neighboring macrocells in step 201. Thus, the femtocell 210 obtains IDentification (ID) information of the neighboring macrocell and ID information of the TA of the neighboring macrocell. Herein, the found macrocell is paired with the femtocell. In step 203, the femtocell 210 transmits a femtocell registration request message to the femtocell manager 220. Herein, the femtocell registration request message can include information of Table 1.

TABLE 1

| | |
|---|---|
| Femtocell ID | SEC12345 |
| Femtocell location | [latitude], [longitude] |
| Neighboring macrocell ID (=paired | SuwonA, SuwonB, |
| macrocell ID) | SuwonC |
| TA ID of neighboring macrocell | 123 |
| Terminal ID registered to femtocell | abcd1, abcd2, abcd3, abcd4 |

In step 205, the femtocell manager 220 receiving the femtocell registration request message stores ID information of the femtocell 210, location information, neighboring macrocell ID information, TA ID information of the neighboring macrocell, and ID information of the terminal registered to the femtocell 210, and transmits a femtocell registration success message informing of the registration complete of the femtocell 210.

In step 207, the femtocell 210 transmits the femtocell information to an upper node 230 over the backhaul network so as to provide its registered terminal 240 with the femtocell information including the ID information of the femtocell 210, the neighboring macrocell ID information, and the TA ID information of the neighboring macrocell.

In step 209, the upper node 230 forwards the femtocell information to the registered terminal 240. In so doing, when the terminal 240 is in a sleep mode or an idle mode, the upper node 230 activates the registered terminal 240 through a paging procedure and then transmits the femtocell information. Although it is not depicted in FIG. 2, before receiving the femtocell information, the terminal 240 can perform an authentication procedure with the femtocell manager 220.

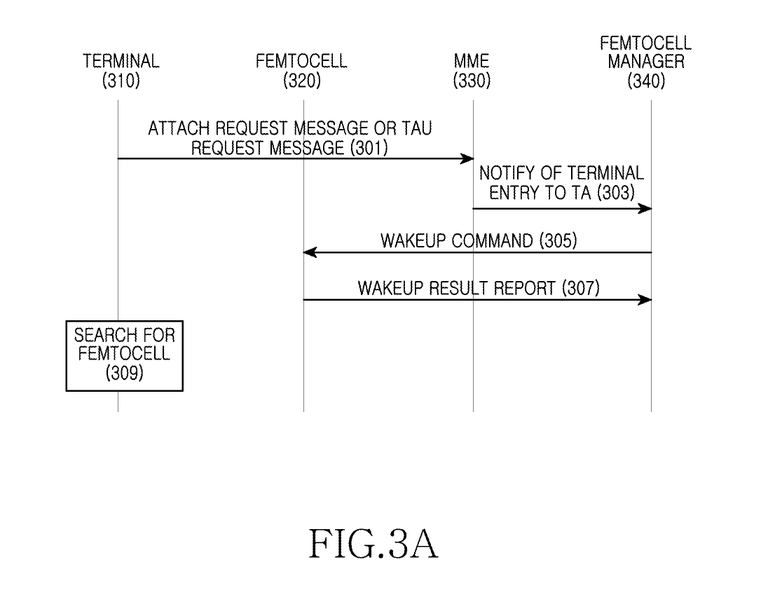

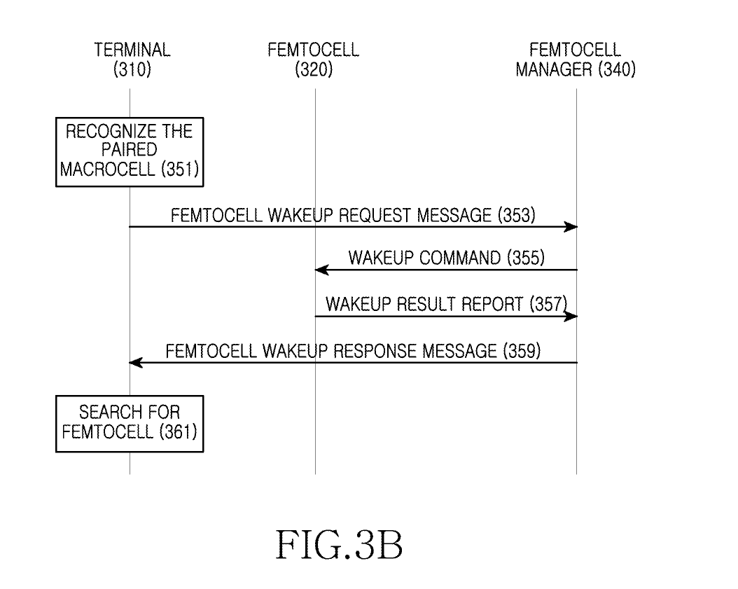

FIGS. 3A and 3B illustrate signal exchanges for a wakeup status transition of a femtocell in a broadband wireless communication system according to an exemplary embodiment of the present invention. FIGS. 3A and 3B depict two exemplary embodiments of the signal exchange of the femtocell to transition to the wakeup mode.

Referring to FIG. 3A, a terminal 310 sends a request to the MME 330. In step 301, the terminal 310 transmits a Tracking Area Update (TAU) request message or an attach request message. When migrating from the different TA to the TA registered to the femtocell 320, the terminal 310 transmits the TAU request message. When entering the network in the registered TA; that is, when attempting to attach to the network, the terminal 320 transmits the attach request message. The TAU request message or the attach request message includes a femto-Indication flag field. The femto-Indication flag field is set to ‘On’.

In step 303, the MME 330 receiving the TAU request message or the attach request message confirms that the femto-Indication flag field is set to ‘On’, and notifies the femtocell manager 340 that the terminal 310 enters the TA. In step 305, the femtocell manager 340 transmits a wakeup command to the femtocell 320.

Hence, in step 307, the femtocell 320 transitions to the wakeup status and transmits a wakeup result report. In step 309, the terminal 310 searches for the femtocell 320. The femtocell 320 maintains the wakeup status until the terminal 310 releases the network; that is, detaches from the network or migrates to the TA not registered to the femtocell 320. When the terminal 310 detaches from the network or migrates to the TA not registered to the femtocell 320, the MME 330 notifies to the femtocell manager 340 and the femtocell manager 340 transmits a sleep command to the femtocell 320, which are not illustrated in FIG. 3A.

Referring to FIG. 3B, a terminal 310 sends a request to the femtocell manager 340. The terminal 310 recognizes that it migrates into the paired macrocell in step 351. When the ID information of the macro base station detected from a signal received from the macro base station at the current location is the same as the ID information of the paired macrocell, the terminal 310 determines the entry to the paired macrocell. Hence, in step 353, the terminal 310 transmits to the femtocell manager 340, a femtocell wakeup request message requesting the wakeup of the femtocell. Herein, the femtocell wakeup request message includes the ID information of the terminal 310.

In step 355, the femtocell manager 340 receiving the femtocell wakeup request message recognizes, based on the ID information of the terminal 310, that the terminal 310 is registered to the femtocell 320, and transmits a wakeup command to the femtocell 320. Accordingly, the femtocell 320 transitions to the wakeup status and transmits the wakeup result report in step 357.

In step 359, the femtocell manager 340 transmits a wakeup response message including the wakeup result of the femtocell 320 to the terminal 310. Next, the terminal 310 searches for the femtocell 320 in step 361. At this time, when the ID information of the paired macrocell is not detected during the search, the terminal 310 aborts the search. The femtocell 320 maintains the wakeup status until the terminal 310 is detached or leaves the macrocell paired with the femtocell 320. When the terminal 310 is detached, the MME 330 notifies this to the femtocell manager 340 and the femtocell manager 340 transmits the sleep command to the femtocell 320. When the terminal 310 leaves the macrocell paired with the femtocell 320, the terminal 310 notifies this to the femtocell manager 340 and femtocell manager 340 transmits the sleep command to the femtocell 320.

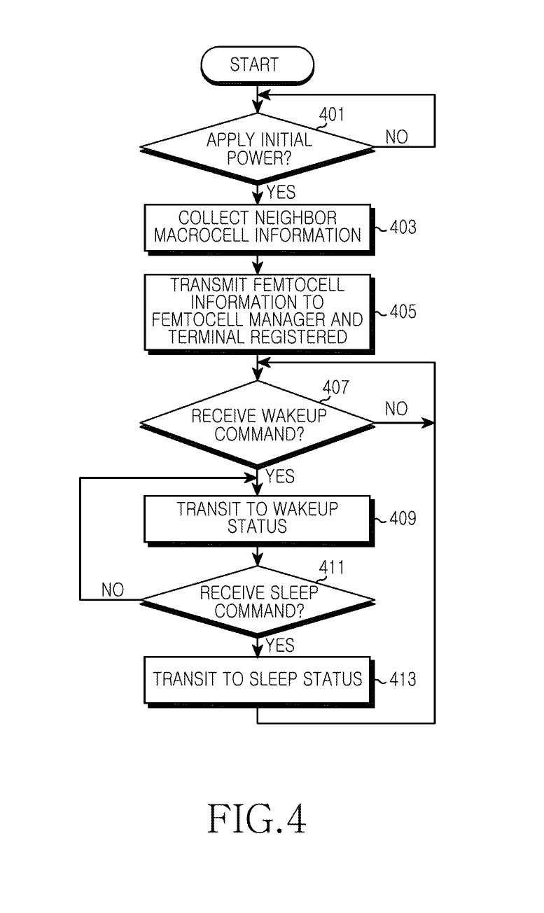

FIG. 4 illustrates a method for changing the status of a femto base station in a broadband wireless communication system according to an exemplary embodiment of the present invention.

Referring to FIG. 4, in step 401, a femto base station determines whether the initial power is applied. The initial power is applied when the user installs the femto base station.

In step 403, when the initial power is applied, the femto base station collects information of the neighboring macrocell. How to collect the information of the neighboring macrocell varies according to whether the femto base station has an Over The Air Receiver (OTAR) function. The OTAR function is the function for measuring the communication environment around the femtocell. With the OTAR function, the femto base station directly collects the information of the neighboring macrocell using the received signals. In contrast, without the OTAR function, the femto base station requests and receives the information of the neighboring macrocell to and from the femtocell manager. Herein, the information of the neighboring macrocell includes the ID information of the neighboring macrocell and the ID information of the TA of the neighboring macrocell.

In step 405, the femto base station transmits the femtocell information to the femtocell manager and the terminal registered to the femtocell. Herein, the femtocell information includes at least one of the ID information of the femtocell, the location of the femtocell, the ID information of the neighboring macrocell, the ID information of the TA of the neighboring macrocell, and the ID information of the terminal registered to the femtocell. Since the femtocell manager and the femtocell are connected over the backhaul network, the femto base station transmits the femtocell information to the femtocell manager over the backhaul network. Since the terminal is not accessing the femtocell, the femto base station transmits the femtocell information to the terminal over the network.

In step 407, the femto base station determines whether the wakeup command is received from the femtocell manager. Upon receiving the wakeup command, the femto base station transitions to the wakeup status and operates in the service available mode in step 409. That is, the femto base station periodically transmits the signal to inform of the existence of the femtocell, generates the link to the terminal according to the access request of the terminal registered to the femtocell, and communicates with the terminal.

In step 411, the femto base station determines whether the sleep command is received from the femtocell manager. Receiving the sleep command, the femto base station transitions to the sleep status in step 413. That is, to minimize the power consumption, the femto base station stops transmitting the signal to inform of the existence of the femtocell.

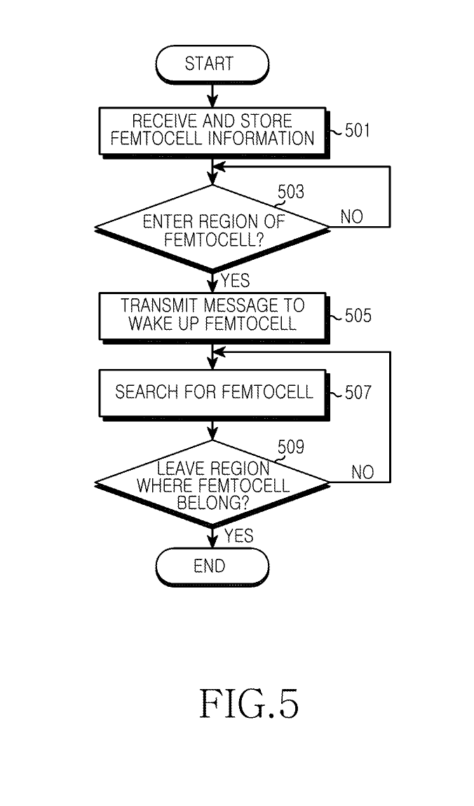

FIG. 5 illustrates a method of the terminal for searching for a femtocell in a broadband wireless communication system according to an exemplary embodiment of the present invention.

Referring to FIG. 5, in step 501, a terminal receives and stores the femtocell information of the femtocell to which the terminal is registered. Herein, the femtocell information includes at least one of the ID information of the femtocell, the location of the femtocell, the ID information of the neighboring macrocell adjacent to the femtocell, the ID information of the TA of the neighboring macrocell, and the ID information of the terminal registered to the femtocell. In the sleep mode or the idle mode before receiving the femtocell information, the terminal attaches to the network through the paging procedure and then receives the femtocell information.

In step 503, the terminal determines whether it enters the region where the femtocell belongs. Whether the terminal enters the region where the femtocell belongs is determined based on the TA of the current macrocell of the terminal according to an exemplary implementation, or based on the current macrocell of the terminal according to another exemplary implementation. In an exemplary implementation, when the ID information of the TA of the current macrocell of the terminal is the same as the ID information of the TA of the neighboring macrocell, the terminal determines the entry to the region where the femtocell belongs. In another exemplary implementation, when the ID information of the current macrocell of the terminal is the same as the ID information of the neighboring macrocell, the terminal determines the entry to the region where the femtocell belongs.

If it is determined in step 503 that the terminal enters the region where the femtocell belongs, the terminal transmits a message for changing the femtocell to the wakeup status in step 505. In an exemplary implementation, the terminal transmits to the MME the TAU message or the attach request message including the femto-Indication flag field set to ‘On’. The TAU message is used for the entry through the TA movement, and the attach request message is used for the network entry; that is, for the entry through attaching to the network. In another exemplary implementation, the terminal transmits the wakeup request message including the ID Information of the terminal, to the femtocell manager.

In step 507, the terminal searches for the femtocell. That is, the terminal attempts to detect the signal informing of the existence of the femtocell. Although it is not illustrated in FIG. 5, the terminal can recognize the femtocell, access the femtocell, and then conduct the communication.

In step 509, the terminal determines whether it leaves the region where the femtocell belongs. In an exemplary implementation, the terminal determines whether it leaves the region where the femtocell belongs, according to the ID information of the TA of the current macrocell of the terminal. In another exemplary implementation, the terminal determines whether it leaves the region where the femtocell belongs, according to the current macrocell of the terminal. Upon leaving the femtocell region, the terminal stops searching for the femtocell and finishes this process.

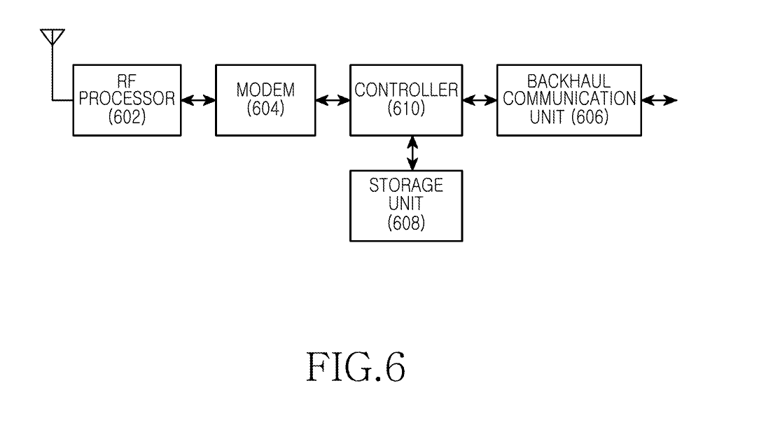

FIG. 6 is a block diagram of a femto base station in a broadband wireless communication system according to an exemplary embodiment of the present invention.

Referring to FIG. 6, a femto base station includes a Radio Frequency (RF) processor 602, a modem 604, a backhaul communication unit 606, a storage unit 608, and a controller 610.

The RF processor 602 performs functions, such as signal band conversion and amplification, to transmit and receive signals over a radio channel. That is, the RF processor 602 up-converts a baseband signal output from the modem 604 to the RF signal and transmits the RF signal over an antenna, and down-converts the RF signal received over the antenna to the baseband signal.

The modem 604 converts the baseband signal and a bit string according to a physical layer standard of the system. For example, to transmit data, the modem 604 generates complex symbols by encoding and modulating the transmit bit string, maps the complex symbols to subcarriers, and constitutes OFDM symbols by applying Inverse Fast Fourier Transform (IFFT) and inserting a Cyclic Prefix (CP). When receiving data, the modem 604 splits the baseband signal output from the RF processor 602 to OFDM symbols, restores the signals mapped to the subcarriers using FFT, and restores the receive bit string by demodulating and decoding the signals.

The backhaul communication unit 606 provides an interface for the femto base station to communicate with other entities in the network. More specifically, the backhaul communication unit 606 converts the bit string transmitted by the femto base station to a physical signal, and converts the physical signal received at the femto base station to the bit string. That is, the backhaul communication unit 606 processes the data transmitted and received to and from the femtocell manager or the upper node.

The storage unit 608 stores data and program codes required for the operations of the femto base station. For example, the storage unit 608 stores the femtocell information provided from the controller 610. Herein, the femtocell information includes at least one of the ID information of the femtocell, the location of the femtocell, the ID information of the neighboring macrocell, the ID information of the TA of the neighboring macrocell, and the ID information of the terminal registered to the femtocell.

The controller 610 controls the functions of the femto base station. For example, the controller 610 processes the received data restored by the modem 604 and provides the transmit data to the modem 604. The controller 610 analyzes a control signal in the received data and controls according to information contained in the control message. More particularly, the controller 610 controls the functions for changing the status of the femto base station. The operations of the controller 610 for the status transition are explained now.

When the initial power of the femto base station is applied, the controller 610 collects the information of the neighboring macrocell. When the femto base station has the OTAR function, the controller 610 directly searches for neighboring macrocells using the signals received via the RF processor 602 and the modem 604. In contrast, without the OTAR function, the controller 610 requests and receives the information of the neighboring macrocell to and from the femtocell manager via the backhaul communication unit 606. After collecting the information of the neighboring macrocell, the controller 610 transmits the femtocell information to the femtocell manager and the terminal registered to the femtocell. Next, when receiving the wakeup command from the femtocell manager, the controller 610 transitions to the wakeup status and operates in the service available mode. Next, when receiving the sleep command from the femtocell manager, the controller 610 switches to the sleep status.

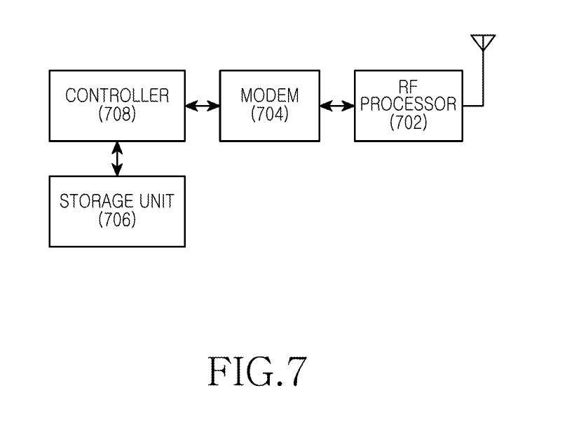

FIG. 7 is a block diagram of a terminal in a broadband wireless communication system according to an exemplary embodiment of the present invention.

Referring to FIG. 7, a terminal includes an RF processor 702, a modem 704, a storage unit 706, and a controller 708.

The RF processor 702 performs functions, such as signal band conversion and amplification, to transmit and receive signals over a radio channel. The RF processor 702 up-converts a baseband signal output from the modem 704 to an RF signal and transmits the RF signal over an antenna, and down-converts the RF signal received over the antenna to the baseband signal.

The modem 704 converts the baseband signal and a bit string according to the physical layer standard of the system. For example, to transmit data, the modem 704 generates complex symbols by encoding and modulating the transmit bit string, maps the complex symbols to subcarriers, and constitutes OFDM symbols by applying the IFFT and inserting the CP. When receiving data, the modem 704 splits the baseband signal output from the RF processor 702 to OFDM symbols, restores the signals mapped to the subcarriers using the FFT, and restores the receive bit string by demodulating and decoding the signals.

The storage unit 706 stores data and program codes required for the operations of the terminal. For example, the storage unit 706 stores the femtocell information provided from the controller 708. Herein, the femtocell information includes at least one of the ID information of the femtocell to which the terminal is registered, the location of the femtocell, the ID information of the neighboring macrocell adjacent to the femtocell, the ID information of the TA of the neighboring macrocell, and the ID information of the terminal registered to the femtocell.

The controller 708 controls the functions of the terminal. For example, the controller 708 processes the received data restored by the modem 704 and provides the transmit data to the modem 704. The controller 708 analyzes a control signal in the received data and controls the signal according to information contained in the control message. More particularly, the controller 708 controls the functions for searching for the femtocell. The operations of the controller 610 for searching for the femtocell are explained now.

The controller 708 receives and stores the femtocell information of the femtocell to which the terminal is registered, via the RF processor 702 and the modem 704. In the sleep mode or the idle mode before receiving the femtocell information, the controller 708 attaches to the network through the paging procedure and then receives the femtocell information.

When entering the region where the femtocell belongs, the controller 708 transmits the message for changing the femtocell to the wakeup status. Herein, whether the terminal enters the region where the femtocell belongs is determined based on the ID information of the TA of the current macrocell of the terminal according to an exemplary implementation, or based on the current macrocell of the terminal according to another exemplary embodiment. In an exemplary implementation, when the ID information of the TA of the current macrocell of the terminal is the same as the ID information of the TA of the neighboring macrocell, the controller 708 determines the entry to the region where the femtocell belongs. In another exemplary implementation, when the ID information of the current macrocell of the terminal is the same as the ID information of the neighboring macrocell, the controller 708 determines the entry to the region where the femtocell belongs. When the terminal enters the femtocell region, in an exemplary implementation, the controller 708 generates and transmits to the MME the TAU message or the attach request message including the femto-Indication flag field set to ‘On’. In another exemplary implementation, the controller 708 generates and transmits the wakeup request message including the ID Information of the terminal, to the femtocell manager. The controller 708 searches for the femtocell. That is, the controller 708 attempts to detect the signal informing of the existence of the femtocell, from the signals received through the RF processor 702. Upon detecting the femtocell, the controller 708 accesses the femtocell and then conducts the communication. Next, when leaving the femtocell region, the controller 708 stops searching for the femtocell.

In the broadband wireless communication system including the femtocell and the macrocell, the interference on the neighboring macrocell can be minimized by controlling the status of the femtocell in the wakeup status or in the sleep status. Since the terminal searches for the femtocell only within the certain region, unnecessary power consumption can be avoided.

While the invention has been shown and described with certain exemplary embodiments thereof, it will be understood that various changes in form and details may be made therein without departing from the spirit and scope of the invention as defined by their appended claims and their equivalents.

What is claimed is:

1. A method for operating a terminal in a wireless communication system comprising a macrocell and a femtocell, the method comprising:
receiving femtocell information relating to a femtocell to which the terminal is registered;
determining whether the terminal enters a region where the femtocell belongs, using the femtocell information;
when entering the region where the femtocell belongs, transmitting a message to wake up the femtocell; and
searching for the femtocell.

2. The method of claim 1, wherein the femtocell information comprises at least one of IDentification (ID) information of the femtocell, a location of the femtocell, ID information of a neighboring macrocell adjacent to the femtocell, ID information of a Tracking Area (TA) of the neighboring macrocell, and ID information of a terminal registered to the femtocell.

3. The method of claim 2, wherein the region where the femtocell belongs is a TA of the neighboring macrocell adjacent to the femtocell.

4. The method of claim 3, wherein the determining of whether the terminal enters the region where the femtocell belongs comprises, when ID information of the TA of the macrocell of the terminal is the same as ID information of the TA of the neighboring macrocell, determining the entry to the region where the femtocell belongs.

5. The method of claim 3, wherein the transmitting of the message comprises sending a Tracking Area Update (TAU) message or an attach request message which comprises a femto-Indication flag field set to ‘On’, to a Mobile Management Entity (MME).

6. The method of claim 2, wherein the region where the femtocell belongs is a coverage area of the neighboring macrocell adjacent to the femtocell.

7. The method of claim 6, wherein the determining of whether the terminal enters the region where the femtocell belongs comprises, when ID information of the macrocell of the terminal is the same as ID information of the neighboring macrocell, determining the entry to the region where the femtocell belongs.

8. The method of claim 7, wherein the transmitting of the message comprises sending a wakeup request message which comprises ID information of the terminal, to a femtocell manager.

9. The method of claim 1, further comprising:
when leaving the region where the femtocell belongs, transmitting a message to make the femtocell sleep.

10. A method for operating a femto base station in a wireless communication system comprising a macrocell and a femtocell, the method comprising:
collecting information of at least one neighboring macrocell;
sending femtocell information comprising the information of the neighboring macrocell, to a femtocell manager and a terminal registered to the femto base station; and
when receiving a wakeup command, transitioning to a wakeup status.

11. The method of claim 10, wherein the femtocell information comprises at least one of IDentification (ID) information of the femtocell, a location of the femtocell, ID information of a neighboring macrocell adjacent to the femtocell, ID information of a Tracking Area (TA) of the neighboring macrocell, and ID information of a terminal registered to the femtocell.

12. The method of claim 11, wherein the collecting of the information of the at least one neighboring macrocell comprises collecting the information of the at least one neighboring macrocell using signals received from the at least one neighboring macrocell.

13. The method of claim 11, wherein the collecting of the information of the at least one neighboring macrocell comprises requesting the information of the at least one neighboring macrocell, to the femtocell manager.

14. An apparatus of a terminal in a wireless communication system comprising a macrocell and a femtocell, the apparatus comprising:
a modem for receiving femtocell information relating to a femtocell to which the terminal is registered; and
a controller for determining whether the terminal enters a region where the femtocell belongs, using the femtocell information, for controlling to transmit a message to wake up the femtocell when entering the region where the femtocell belongs, and for searching for the femtocell.

15. The apparatus of claim 14, wherein the femtocell information comprises at least one of IDentification (ID) information of the femtocell, a location of the femtocell, ID information of a neighboring macrocell adjacent to the femtocell, ID information of a Tracking Area (TA) of the neighboring macrocell, and ID information of a terminal registered to the femtocell.

16. The apparatus of claim 15, wherein the region where the femtocell belongs is a TA of the neighboring macrocell adjacent to the femtocell.

17. The apparatus of claim 16, wherein, when ID information of the TA of the macrocell of the terminal is the same as ID information of the TA of the neighboring macrocell, the controller determines the entry to the region where the femtocell belongs.

18. The apparatus of claim 16, wherein the message is a Tracking Area Update (TAU) message or an attach request message comprising a femto-Indication flag field set to ‘On’, and is transmitted to a Mobile Management Entity (MME).

19. The apparatus of claim 15, wherein the region where the femtocell belongs is a coverage area of the neighboring macrocell adjacent to the femtocell.

20. The apparatus of claim 19, wherein, when ID information of the macrocell of the terminal is the same as ID information of the neighboring macrocell, the controller determines the entry to the region where the femtocell belongs.

21. The apparatus of claim 20, wherein the message is a wakeup request message comprising ID information of the terminal, and is transmitted to a femtocell manager.

22. The apparatus of claim 14, wherein, when leaving the region where the femtocell belongs, the controller controls to transmit a message to make the femtocell sleep.

23. An apparatus of a femto base station in a wireless communication system comprising a macrocell and a femtocell, the apparatus comprising:
a transmitter for transmitting femtocell information comprising information of at least one neighboring macrocell, to a femtocell manager and a terminal registered to the femto base station; and
a controller for collecting the information of the at least one neighboring macrocell, and for transitioning to a wakeup status when receiving a wakeup command.

24. The apparatus of claim 23, wherein the femtocell information comprises at least one of IDentification (ID) information of the femtocell, a location of the femtocell, ID information of a neighboring macrocell adjacent to the femtocell, ID information of a Tracking Area (TA) of the neighboring macrocell, and ID information of a terminal registered to the femtocell.

25. The apparatus of claim 24, wherein the controller collects the information of the at least one neighboring macrocell using signals received from the at least one neighboring macrocell.

26. The apparatus of claim 24, wherein, to collect the information of the at least one neighboring macrocell, the controller requests the information of the at least one neighboring macrocell, to the femtocell manager.
